(19) United States
(12) Patent Application Publication
(10) Pub. No.: US 2013/0220975 A1
(43) Pub. Date: Aug. 29, 2013

(54) HYBRID PLASMA PROCESSING SYSTEMS

(71) Applicant: Rajinder Dhindsa, San Jose, CA (US)

(72) Inventor: Rajinder Dhindsa, San Jose, CA (US)

(21) Appl. No.: 13/405,465

(22) Filed: Feb. 27, 2012

(51) Int. Cl. B44C 1/22; B05C 9/00

(52) U.S. Cl. 216/68; 156/345.38

(57) ABSTRACT

A hybrid plasma processing system and methods for manufacturing and operating same are disclosed. The hybrid plasma processing system includes an RF-powered lower electrode for supporting the substrate during processing and a hybrid upper electrode disposed in a spaced-apart relationship above the lower electrode. The hybrid upper electrode may be thermally controlled and includes a first plate formed of a first material having a first electrical resistivity, a conductive grounded plate having therein a plurality of radial slots and disposed above the first plate. The conductive plate is formed of a second material having a second electrical resistivity different from the first electrical resistivity. The hybrid upper electrode also includes an RF-powered inductive coil disposed above the conductive ground plate.

### BACKGROUND OF THE INVENTION

Plasma processing systems have long been employed to process substrates (e.g., wafers or flat panels or LCD panels) to form integrated circuits or other electronic products. Popular plasma processing systems may include capacitively coupled plasma processing systems (CCP) or inductively coupled plasma processing systems (ICP), among others.

In a purely capacitively coupled plasma processing system, one or more electrodes may be powered with RF energy to capacitively induce plasma, which is then used to process the substrate. In an example CCP system, the substrate may be disposed on top of one of the electrodes (which also functions as a chuck or work-piece holder). The substrate-supporting electrode may then be powered with one or more RF power sources.

Another electrode may be disposed above the substrate and may be grounded. The interaction between these two plates generates capacitively coupled plasma for processing the substrate.

Inductively coupled plasma processing systems tend to be employed when a higher density plasma is desired. An inductively coupled plasma processing chamber typically employs an inductive coil to inductively energize and sustain a plasma for processing. Both ICP and CCP systems are well known in the art and will not be further elaborated here.

However, as is well known to those skilled in the art, ICP systems offer different ranges of plasma density, chemistry, dissociation characteristics, ion energy control, etc., and have different maintainability issues and advantages/disadvantages compared to CCP systems. The inventor herein realizes that often times, it is desirable to have features associated with ICP systems in a CCP chamber, and vice versa. Such a hybrid system would offer the best of both and would also offer control knobs and operating ranges and maintainability advantages (such as in-situ cleaning) not previously possible with a chamber utilizing either ICP technology alone or CCP technology alone.

The present invention relates to systems and methods for creating and operating a hybrid plasma processing system that combines features and functions of both an ICP chamber and a CCP chamber.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in accordance with an embodiment of the invention, a simplified cross-section view of a hybrid upper electrode.

FIG. 2 shows, in accordance with an embodiment of the invention, a simplified top-down view of a hybrid upper electrode

FIG. 3 shows, in accordance with an embodiment of the invention, a hybrid plasma processing system.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

The invention relates, in one or more embodiments, to a hybrid plasma processing system capable of performing in the capacitively coupled mode, the inductively coupled mode, or both simultaneously. In one or more embodiments, the hybrid plasma processing system has a chamber that includes a lower electrode. The lower electrode is powered by one or more RF power sources in the range of kHz or MHZ, including tens or hundreds of MHz, using one or more RF signals. A substrate is disposed on the lower electrode during plasma processing.

The hybrid plasma processing system further includes a hybrid upper electrode that includes at least a first plate formed of a material having a first electrical resistivity. Preferably, the first material is a high electrical resistivity material, such as high resistivity (as opposed to low resistivity) Si or SiC, for example. A conductive grounded plate is disposed above the first plate in the direction that is distal (further away) from the lower electrode compared to the first plate.

Above the conductive grounded plate is at least one inductive coil configured to inductively couple a plasma to process the substrate. The inductive coil is typically powered by an RF power supply, which may be in the range of kHz or MHZ, including tens or hundreds of MHz. In one or more embodiments, the inductive coil is disposed inside channels formed in an electrically conductive structure or plate. The inductive coil and/or the electrically conductive structure encapsulating the inductive coil are disposed more distally from the lower electrode compared to the conductive grounded plate.

In one or more embodiments, a plurality of radial slots is formed in the first plate and/or the conductive grounded plate. These radial slots are dimensioned to permit the B-field to penetrate across (same plane as radial slot) while blocking the E-field in the azithmuthal direction. Further, the slot width and thickness are selected such that the circulation current is minimized in the slotted plate(s). In one or more embodiments, the slots may be formed partially or completely through either one or both of the first plate and the conductive grounded plate. To improve mechanical rigidity and/or reduce maintainability burdens, the radial slots may be filled with a suitable dielectric material (other than air) that is compatible with the process in the chamber. Quarts may be one such suitable dielectric material, in one or more embodiments.

In one or more embodiments, heating and electrical arrangements are provided to thermally control the temperature of the hybrid upper electrode assembly before, during, and/or after processing. In one or more embodiments, gas passages may be provided in one or both of the first plate and the conductive grounded plate to form a shower head structure. In one or more embodiments, multiple inductive coils may be provided to enable zone control of the inductively coupled power (e.g., an inner coil and an outer coil may be provided). The coils may be supplied with the same or different RF frequencies and may be pulsed if desired.

The features and advantages of embodiments of the invention may be better understood with reference to the figures and discussions that follow.

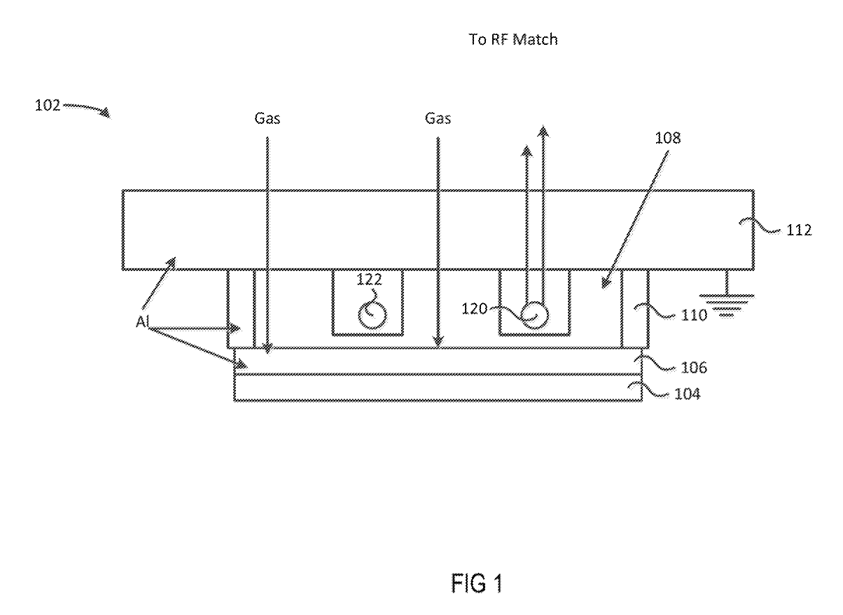

FIG. 1 shows, in accordance with an embodiment of the invention, a simplified cross-section view of a hybrid upper electrode 102, including a first plate 104, typically formed of a high electrical resistance material such as Si or SiC for dielectric etchers or a similarly suitable material that is compatible with plasma processing to be performed.

A conductive grounded plate 106 is disposed, relative to a substrate bearing electrode (disposed in a spaced-apart relationship below first plate 104 and not shown in FIG. 1), more distally than first plate 104. In other words, first plate 104 is disposed between the substrate-bearing electrode and conductive grounded plate 106. In the example of FIG. 1, conductive grounded plate 106 formed of an electrically conductive material, such as aluminum or another suitable electrically conductive material. Conductive grounded plate 106 is bonded or otherwise attached or fastened to first plate 104. In this manner, first plate 104 presents to the plasma a material that is compatible with the plasma process and shields conductive grounded plate 106 from the plasma to reduce/eliminate metal contamination risks.

An inductive coil 120 is shown disposed, relative to the substrate bearing electrode, more distally than conductive grounded plate 106 and first plate 104. In the example of FIG. 1, two separate inductive coils 120 and 122 are provided to afford more granular control over plasma density but multiple coils are not absolutely required in every case.

Also in the example of FIG. 1, the coils are disposed in channels formed in electrically insulating plate 108, which may be formed of, for example, Aluminum Nitride (AlN) or another suitable material. The channels in insulating plate 108 may be filled with a suitable dielectric material if desired in one or more embodiments. Alternatively or additionally, the coils may be bonded and/or made thermally conductive to the electrically insulating plate 108 to facilitate thermal control.

Peripheral ring 110, which may be formed of aluminum for example, is shown encircling the hybrid upper electrode and more specifically in the example of FIG. 1, enclosing electrically insulating plate 108. Peripheral ring provides electrical, thermal, and RF coupling for grounded plate 106 to at least provide a return RF current path (e.g., when the chamber operates in the capacitive mode).

Above peripheral ring 110 is a heating plate 112, which is coupled with heating elements (e.g., fluid or electrical heating mechanism) to provide thermal control for the upper electrode 102. Peripheral ring 110 may be grounded in one or more embodiments.

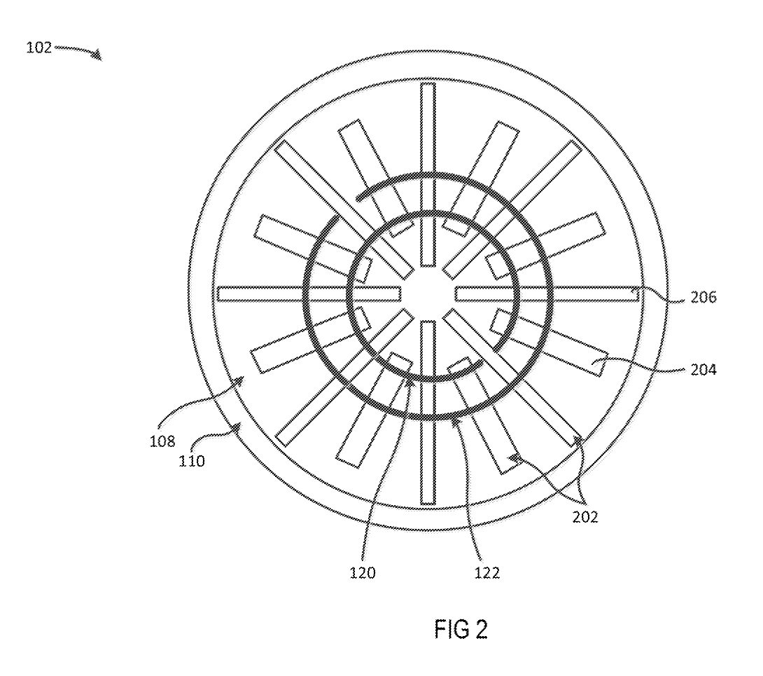

FIG. 2 shows, in accordance with an embodiment of the invention, a simplified top-down view of hybrid upper electrode 102. Coils 120 and 122 are shown disposed inside channels formed in electrically insulating layer 108 as mentioned earlier. Below insulating layer 108 are conductive grounded plate 106 and first plate 104, both of which are provided with radial slots forming at least partially or wholly through at least one, each one, or both of conductive grounded plate 106 and first plate 104.

These radial slots (202, 204, 206, etc.) are preferably symmetrically arranged and configured or dimensioned to permit the magnetic field (B-field) to penetrate across but are sufficiently narrow in cross-section to block the electric field (E-field) in the azithmuthal direction. The slots are oriented from center to edge radially and span at least partially (and in some cases, wholly) from center to edge of the plate. Further, the slot width and thickness is selected such that the circulation current in the slotted plate is minimized. In one or more embodiments, these slots in the conductive grounded plate may line up, completely or partially, with the slots in the Si plate. In this manner, inductive coupling to the plasma from coils 120 and/or 122 is facilitated when these coils are energized with RF energy.

In one or more embodiments, gas passages for injecting process gases into the plasma generating region between the upper and lower electrodes are formed inside first plate 104 and/or conductive plate 106 but shielded from the plasma to prevent the plasma from being formed inside the gas plenum. In one or more embodiments, the gas plenum slots may be formed between the conductive top and bottom plate. Accordingly, fields from the plasma or from the TCP coil cannot penetrate inside the conductive material surrounding the gas plenum slots. In this manner, plasma formation inside the gas plenum slots is prevented.

First plate 104 is preferably made from a high electrical resistivity material in order to improve B-field penetration. A conductive plate (such as conductive Si plate) would have undesirable block B-field penetration from the coils and absorb more of the RF power from the coil in the form of circulation current, which also gives rise to heating problems. With a high electrical resistivity plate (such as high resistivity Si or SiC), process compatibility is achieved while presenting a sufficiently large RF skin depth to allow the B-field to penetrate its thickness. The use of a high electrical resistivity material also decreases RF coupling to the capacitive RF power from the bottom electrode, which may decrease the ion energy across the resistive material, which reduces the etch rate.

In one or more embodiments, segmented (sectorized) wedges of low resistivity material (such as low resistivity Si) may be attached to the conductive grounded plate 106. The seams of the wedges may be interlocked so as to present no line-of-sight from the plasma to the conductive grounded plate 106 behind the wedges. To avoid any arching between the Si sectors at the seams, an insulating filler (e.g., quartz) may be employed.

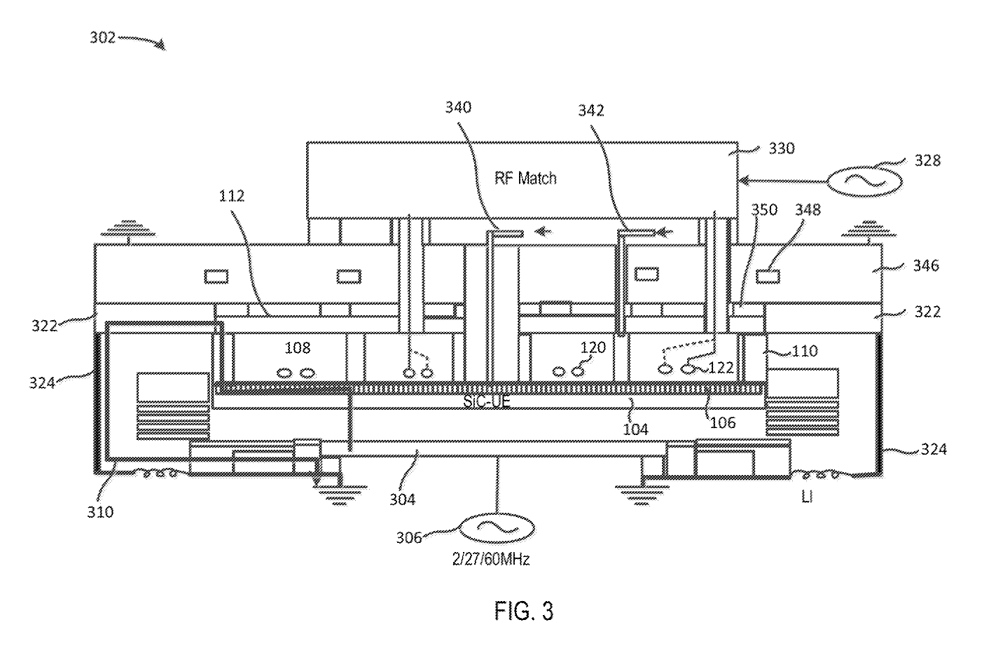

FIG. 3 shows, in accordance with an embodiment of the invention, a hybrid plasma processing system 302, including lower substrate bearing electrode 304 which is shown powered by a RF power supply 306. In the example of FIG. 3, RF power supply 306 provides 3 separate RF frequencies (2, 27, and 60 MHz) although multiple RF frequencies are not absolutely necessary in every case. First plate 104 is shown disposed above the substrate bearing electrode 304. Above first plate 104 is grounded conductive plate 106. Inductive coils 120 and 122 are shown disposed in respective channels formed in electrically insulating plate 108. In the example of FIG. 3, inductive coils 120 and 122 are energized by a RF power source 328 via RF match 330.

Gas inlets 340 and 342 are provided to furnish process gases to the gas passages formed in one or both of first plate 104 and conductive grounded plate 106 for injecting the process gas into the plasma region between the upper and lower electrodes. A peripheral ring 110 is shown encircling electrically insulating plate 108.

As can be seen in FIG. 3, return RF current 310 traverses at least first plate 104, grounded conductive plate 106, heating plate 112, top plate 322, and chamber sidewall 324 to return to ground. One of the upper electrode or lower electrode assemblies may be moved to facilitate wafer insertion and to control the plasma gap during processing.

A cooling plate 346 having therein a plurality of cooling channels 348 is provided to facilitate thermal control of the upper electrode. In the example of FIG. 3, cooling plate 346 is grounded and may be thermally isolated from heating plate 112 using one or more thermal chokes 350.

In practice, plasma processing system 302 may be operated in the CCP mode (e.g., with lower electrode 304 energized and the inductive coils turned off), in the ICP mode (e.g., with lower electrode 304 turned off and the inductive coils energized), or in the hybrid mode where both the lower electrode 304 and the inductive coils are energized. In one or more embodiments, the upper electrode may also be energized with an RF power source, if desired, so that both the upper and lower electrodes are energized in the CCP mode or hybrid mode.

Embodiments of the invention also cover methods to manufacture a hybrid plasma processing system constructed in accordance with the teachings herein. One skilled in the art would understand that components may be provided and coupled together to form the disclosed hybrid plasma processing system or variations thereof. Further, embodiments of the invention also cover methods to process substrates using a hybrid plasma processing system constructed in accordance with the teachings herein. One skilled in the art would be able to operate the disclosed hybrid plasma processing system in the CCP mode, the ICP mode, or the hybrid mode to process substrates given this disclosure.

As can be appreciated from the foregoing, embodiments of the invention relate to a hybrid plasma processing system that can operate in the CCP, the ICP or the hybrid CCP/ICP mode. In this manner, a multi-step recipe needs not require that the substrate be moved from chamber to chamber to be processed with conditions characteristic of a CCP chamber and/or an ICP chamber. The ability to process in the hybrid mode opens up additional process windows and provides additional process control knobs and maintainability advantages (such as in-situ chamber wall conditioning or chamber cleaning) previously unavailable with chambers operating in the CCP mode only or in the ICP mode only.

While this invention has been described in terms of several preferred embodiments, there are alterations, permutations, and equivalents, which fall within the scope of this invention. Although various examples are provided herein, it is intended that these examples be illustrative and not limiting with respect to the invention. Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A plasma processing system having a plasma processing chamber for processing a substrate, comprising:
a first RF power supply;
a second RF power supply;
a lower electrode for supporting said substrate during said processing, said lower electrode being energized by said first RF power supply;
a hybrid upper electrode disposed in a spaced-apart relationship above said lower electrode and comprising
a first plate formed of a first material having a first electrical resistivity,
a conductive grounded plate having therein a plurality of radial slots, said conductive plate being disposed, relative to said lower electrode, more distally than said first plate, said conductive plate formed of a second material having a second electrical resistivity lower than said first electrical resistivity,
an inductive coil disposed, relative to said lower electrode, more distally than said conductive ground plate, said inductive coil being energized by said second RF power supply.

2. The plasma processing system of claim 1 wherein said first plate has therein another plurality of radial slots.

3. The plasma processing system of claim 2 wherein said another plurality of radial slots are filled with a dielectric material other than air.

4. The plasma processing system of claim 1 wherein said first RF power supply is configured to simultaneously provide multiple RF frequencies to said lower electrode during said processing.

5. The plasma processing system of claim 1 further comprising an electrically insulative plate having at least one channel disposed therein, said inductive coil being disposed within said at least one channel.

6. The plasma processing system of claim 5 wherein said electrically insulative plate comprises at least AlN.

7. The plasma processing system of claim 1 further comprising a heater plate disposed, relative to said lower electrode, more distally than said inductive coil.

8. The plasma processing system of claim 1 further comprising a cooling plate disposed, relative to said lower electrode, more distally than said inductive coil.

9. The plasma processing system of claim 1 wherein said first material is comprises at least one of high resistivity Si or SiC.

10. The plasma processing system of claim 1 wherein said second material comprises aluminum.

11. The plasma processing system of claim 1 wherein said plurality of radial slots are at least partially filled with a dielectric material other than air.

12. The plasma processing system of claim 1 wherein said hybrid upper electrode further includes another inductive coil disposed, relative to said lower electrode, more distally than said conductive ground plate, said another inductive coil being disposed over a different spatial region of said lower electrode compared to said inductive coil.

13. The plasma processing system of claim 1 wherein a width of each of said plurality of radial slots is dimensioned to permit a B-field to penetrate said conductive grounded plate while blocking E-field penetration in an azithmuthal direction.

14. A plasma processing system having a plasma processing chamber for processing a substrate, comprising:
a first RF power supply;
a second RF power supply;
a lower electrode for supporting said substrate during said processing, said lower electrode being energized by said first RF power supply;
a hybrid upper electrode disposed in a spaced-apart relationship above said lower electrode and comprising
a first plate formed of a first material having a first electrical resistivity,
a conductive grounded plate having therein a first plurality of radial slots, said conductive plate being disposed, relative to said lower electrode, more distally than said first plate, said conductive plate formed of a second material having a second electrical resistivity different from said first electrical resistivity,
an electrically insulative plate having at least one channel disposed therein, said electrically insulative plate disposed, relative to said lower electrode, more distally than said conductive ground plate,
an inductive coil disposed within said at least one channel of said electrically insulative plate, said inductive coil being energized by said second RF power supply.

15. The plasma processing system of claim 14 wherein said first plurality of radial slots are filled with a dielectric material other than air.

16. The plasma processing system of claim 14 wherein said first RF power supply is configured to simultaneously provide multiple RF frequencies to said lower electrode during said processing.

17. The plasma processing system of claim 14 wherein said electrically insulative plate comprises at least AlN.

18. The plasma processing system of claim 14 wherein said first material is comprises at least one of high resistivity Si or SiC.

19. The plasma processing system of claim 14 wherein said hybrid upper electrode further includes another inductive coil disposed, relative to said lower electrode, more distally than said conductive ground plate, said another inductive coil being disposed over a different spatial region of said lower electrode compared to said inductive coil.

20. The plasma processing system wherein said first plate comprises a plurality of wedges having seams configured to prevent line-of-sight from a plasma generated in said chamber to said conductive grounded plate.

21. A method for processing a substrate in a plasma processing system having a plasma processing chamber for processing a substrate, comprising:
providing a first RF power supply;
providing a second RF power supply;
providing a lower electrode for supporting said substrate during said processing, said lower electrode being energized by said first RF power supply;
providing a hybrid upper electrode disposed in a spaced-apart relationship above said lower electrode and comprising
a first plate formed of a first material having a first electrical resistivity, said first plate having therein a first plurality of radial slots,
a conductive grounded plate having therein a second plurality of radial slots, said conductive plate being disposed, relative to said lower electrode, more distally than said first plate, said conductive plate formed of a second material having a second electrical resistivity lower than said first electrical resistivity,
an electrically insulative plate having at least one channel disposed therein, said electrically insulative plate disposed, relative to said lower electrode, more distally than said conductive ground plate,
an inductive coil disposed within said at least one channel of said electrically insulative plate, said inductive coil being energized by said second RF power supply; and
processing said substrate while energizing at least one of said lower electrode and said inductive coil using at least one of said first RF power supply and said second RF power supply respectively.

22. The method of claim 21 wherein said first and second plurality of radial slots are filled with a dielectric material other than air.

23. The method of claim 21 wherein said first RF power supply is configured to simultaneously provide multiple RF frequencies to said lower electrode during said processing.

24. The method of claim 21 wherein said electrically insulative plate comprises at least AlN.

25. The method of claim 21 wherein said first material is comprises at least one of high resistivity Si or SiC.

26. The method of claim 21 wherein both said lower electrode and said inductive coil are energized during said processing of said substrate using said first RF power supply and said second RF power supply.
